(19) United States
(12) Patent Application Publication
(10) Pub. No.: US 2015/0011104 A1
(43) Pub. Date: Jan. 8, 2015

(54) CONNECTOR FOR REDUCING NEAR-END CROSSTALK

(71) Applicant: SAMSUNG ELECTRONICS CO., LTD., Suwon-si (KR)

(72) Inventors: Kyeong-jae LEE, Seoul (KR); Jong-hwa KIM, Suwon-si (KR); Sung-kyu JUNG, Seoul (KR); Ji-eun SHIN, Suwon-si (KR); Ju-seok YOON, Suwon-si (KR)

(73) Assignee: SAMSUNG ELECTRONICS CO., LTD., Suwon-si (KR)

(21) Appl. No.: 14/322,518

(22) Filed: Jul. 2, 2014

Related U.S. Application Data
(60) Provisional application No. 61/842,026, filed on Jul. 2, 2013.
(60) Provisional application No. 61/870,333, filed on Aug. 27, 2013.

(30) Foreign Application Priority Data
Nov. 29, 2013 (KR) 10-2013-0147063

(51) Int. Cl. H01R 13/6471; H01R 13/652; H01R 24/60

(52) U.S. Cl. CPC H01R 13/6471; H01R 24/60; H01R 13/652
USPC 439/108; 439/660

(57) ABSTRACT

A connector is providing for reducing near end cross-talk (NEXT). The connector includes a first pin set having sequentially arranged pins configured to transmit a uni-directional signal, a single ended pin adjacent to the first pin set, and a second pin set having sequentially arranged pins adjacent to the single ended pin and having sequentially arranged pins configured to transmit a bi-directional signal.

### CROSS-REFERENCE TO RELATED APPLICATIONS

This application claims benefit from U.S. Provisional Patent Application No. 61/842,026, filed on Jul. 2, 2013, U.S. Provisional Patent Application No. 61/870,333, filed on Aug. 27, 2013, in the United States Patent and Trademark Office, and Korean Patent Application No. 10-2013-0147063, filed on Nov. 29, 2013, in the Korean Intellectual Property Office, the disclosures of which are incorporated herein by reference, in their entireties.

### BACKGROUND

1. Technical Field

Apparatuses and methods consistent with the exemplary embodiments relate to a connector. More particularly, the exemplary embodiments relate to a connector for reducing near-end crosstalk (NEXT).

2. Description of the Related Art

Various connectors have been proposed for physical connection between devices. For example, connector design for a wired interface such as a high definition multimedia interface (HDMI), a digital video/visual interface (DVI), and a mobile high-definition link (MHL) have been proposed. A high definition multimedia interface (HDMI) is one of uncompress types of digital video/audio interface standards. Mobile high-definition link (MHL) is an interface standard similar to HDMI and relates to a high-speed wired interface standard for connection between a mobile device and a television (TV). A DVI is a wired interface standard for digitizing and transmitting a video image. These standards provides a protocol for transmitting a large amount of data between a multimedia source such as a smart phone, a set-top box, a DVD player, etc., and sink devices such as an audio/video (AV) device, a monitor, a digital TV, etc. In addition, connectors for various interfaces have been designed.

FIG. 1 is a diagram which illustrates the structure of an outer appearance of a male connector 10.

As illustrated in FIG. 1, the male connector 10 includes a substrate 12 to which a plurality of pins for transmission of signals between devices are fixed, and a housing 11 for accommodating the substrate 12.

The substrate 12 fixes the plural pins that are spaced apart from each other by a predetermined interval, and strongly fixes a coupling portion in response to the male connector 10 being inserted into a female connector. In response to the plural pins being connected to an opposite connector, a coupling portion for transferring signals may be formed of any one of gold plating, silver plating, tin plating, nickel plating, etc.

The housing 11 accommodates the substrate 12 and has an accommodation groove for accommodation of the opposite connector. FIG. 1(A) is a perspective view of the male connector 10, and FIG. 1(B) is a lateral cross-sectional view of the male connector 10 of FIG. 1(A).

However, crosstalk may occur between pins of these connectors. Far-end crosstalk (hereinafter, referred to as far-end crosstalk or FEXT) is generated in an induced circuit from an inductive circuit, and specially, is generated in an opposite end to a signal source of the inductive circuit. FEXT is known to be easily controlled.

On the other hand, crosstalk known as near-end crosstalk (NEXT) is generated between pins for transmitting adjacent signals. In particular, it is known that, when opposite-direction signals are transmitted, NEXT becomes serious.

Accordingly, there is a need for a design for a connector structure for reducing NEXT.

### SUMMARY

Exemplary embodiments overcome the above disadvantages and other disadvantages not described above. Also, the exemplary embodiments are not required to overcome the disadvantages described above, and an exemplary embodiment may not overcome any of the problems described above.

The exemplary embodiments provide a connector for reducing near-end crosstalk (NEXT).

According to an aspect of the exemplary embodiments, a connector includes a first pin set having sequentially arranged pins configured to transmit a uni-directional signal, a single ended pin adjacent to the first pin set, and a second pin set having sequentially arranged pins adjacent to the single ended pin and having sequentially arranged pins configured to transmit a bi-directional signal.

The first pin set may include a plurality of pins configured to transmit audio/video (AV) data through a high-speed uni-directional signal.

The first pin set may have sequentially arranged pins B1+, B1−, B2+, B2−, B3+, B3−, B4+, B4−, B5+, and B5− and transmit a uni-directional signal.

The single ended pin may transmit a device identification signal.

The second pin set may include a plurality of pins configured to transmit a clock signal through a high-speed bi-directional signal or transmit environment configuration data.

The second pin set may include sequentially arranged pins A1+ and A1− and transmits a bi-directional signal.

The connector may further include a single ended pin adjacent to the second pin set.

According to another aspect of an exemplary embodiment, a connector may include a first pin set having sequentially arranged pins configured to transmit a uni-directional signal, and a second pin set having sequentially arranged pins configured to transmit a bi-directional signal, wherein the first and second pin sets are disposed on physically separated substrates.

The first pin set may include a plurality of pins configured to transmit audio/video (AV) data through a high-speed uni-directional signal.

The first pin set may have sequentially arranged pins B1+, B1−, B2+, B2−, B3+, B3−, B4+, B4−, B5+, and B5− and transmit a uni-directional signal.

The second pin set may include a plurality of pins configured to transmit a clock signal through a high-speed bi-directional signal or transmit environment configuration data.

The second pin set may include sequentially arranged pins A1+ and A1− and transmit a bi-directional signal.

The connector may further include a single ended pin adjacent to the second pin set.

The single ended pin set may include at least one of a pin C1 configured to transmit a power signal, a pin C2 configured to transmit a control signal, and a pin C3 configured to transmit a device identification signal.

The first pin set and the second pin set may be disposed on substrates that are physically separated by an insulating plate.

The pin C2 may be positioned inside the connector.

According to another aspect of the exemplary embodiments, a connector includes a pin set having sequentially arranged pins including a uni-directional pin C1 configured to transmit a power signal, a bi-directional pin C2 configured to transmit a control signal, a bi-directional pin A1+ configured to transmit a clock signal or to transmit environment configuration data, a ground pin (GND), a bi-directional pin A1− configured to transmit a clock signal or to transmit environment configuration data, a uni-directional pin C3 configured to transmit a device identification signal, a uni-directional pin B1+ configured to transmit audio/video (AV) data, a ground pin (GND), a uni-directional pin B1− configured to transmit AV data, a uni-directional pin B2+ configured to transmit AV data, a ground pin (GND), a uni-directional pin B2− configured to transmit AV data, a uni-directional pin B3+ configured to transmit AV data, a ground pin (GND), a uni-directional pin B3− configured to transmit AV data, a uni-directional pin B4+ configured to transmit AV data, a ground pin (GND), a uni-directional pin B4− configured to transmit AV data, a uni-directional pin B5+ configured to transmit AV data, a ground pin (GND), a uni-directional pin B5− configured to transmit AV data.

According to another aspect of the exemplary embodiments, a connector includes a first pin set and a second pin set, wherein the first pin set has sequentially placed pins including a uni-directional pin C1 configured to transmit a power signal, a uni-directional pin C3 configured to transmit a device identification signal, a bi-directional pin A1+ configured to transmit a clock signal or to transmit environment configuration data, a ground pin (GND), a bi-directional pin A1− configured to transmit a clock signal or to transmit environment configuration data, and a bi-directional pin C2 configured to transmit a control signal, wherein the second pin set has sequentially placed pins including a uni-directional pin B1+ configured transmit AV data, a ground pin (GND), a uni-directional pin B1− configured transmit AV data, a uni-directional pin B2+ configured transmit AV data, a ground pin (GND), a uni-directional pin B2− configured transmit AV data, a uni-directional pin B3+ configured transmit AV data, a ground pin (GND), a uni-directional pin B3− configured transmit AV data, a uni-directional pin B4+ configured transmit AV data, a ground pin (GND), a uni-directional pin B4− configured transmit AV data, a uni-directional pin B5+ configured transmit AV data, a ground pin (GND), and a uni-directional pin B5− configured transmit AV data, and wherein the first pin set and the second pin set are disposed on physically separated substrates.

An exemplary embodiment may provide a connector including: a first pin set having sequentially arranged pins configured to transmit a uni-directional signal; and a second pin set having sequentially arranged pins configured to transmit a bi-directional signal, wherein the first and second pin sets are separated so as to reduce near-end crosstalk (NEXT).

The connector may further include a single ended pin adjacent to the first pin set, wherein the single ended pin is configured to transmit a device identification signal.

According to the aforementioned exemplary embodiments, the embodiments disclose a connector for reducing NEXT.

Additional and/or other aspects and advantages of the exemplary embodiments will be set forth in part in the description which follows and, in part, will be obvious from the description, or may be learned by practice of the exemplary embodiments.

### BRIEF DESCRIPTION OF THE DRAWINGS

The above and/or other aspects will be more apparent by describing certain exemplary embodiments with reference to the accompanying drawings, in which:

FIG. 1 is a diagram which illustrates the structure of an outer appearance of a male connector of the related art;

FIG. 2 is a diagram which illustrates the structure of a 21 pin connector according to an exemplary embodiment;

FIG. 3 is a diagram which illustrates an order of pin arrangement of the connector;

FIG. 4 is a diagram which illustrates physical proximity between a pin A1− and a pin B1+;

FIG. 5 is a diagram which illustrates a near-end crosstalk (NEXT) value between adjacent pins;

FIG. 6 is a diagram which illustrates a pin arrangement of a connector according to an exemplary embodiment;

FIG. 7 is a diagram which illustrates a NEXT value between adjacent pins of an improved connector;

FIG. 8 is a diagram which illustrates the structure of an outer appearance of a connector according to another exemplary embodiment;

FIG. 9 is a diagram which illustrates an arrangement of pins of the connector of FIG. 8;

FIG. 10 is a diagram which illustrates arrangement of pins of a connector;

FIGS. 11 and 12 are diagrams which illustrate an arrangement of pins of a connector according to another exemplary embodiment; and

FIG. 13 is a diagram which illustrates an order of a pin arrangement of the connector.

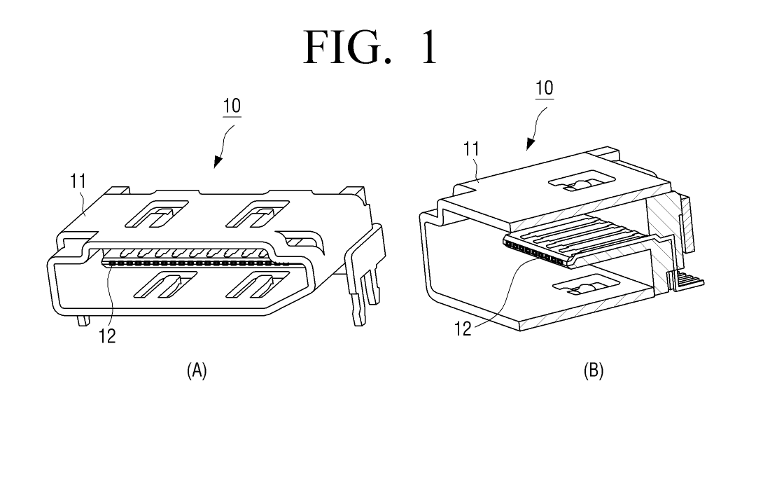

### DETAILED DESCRIPTION OF THE EXEMPLARY EMBODIMENTS

Certain exemplary embodiments will now be described in greater detail with reference to the accompanying drawings.

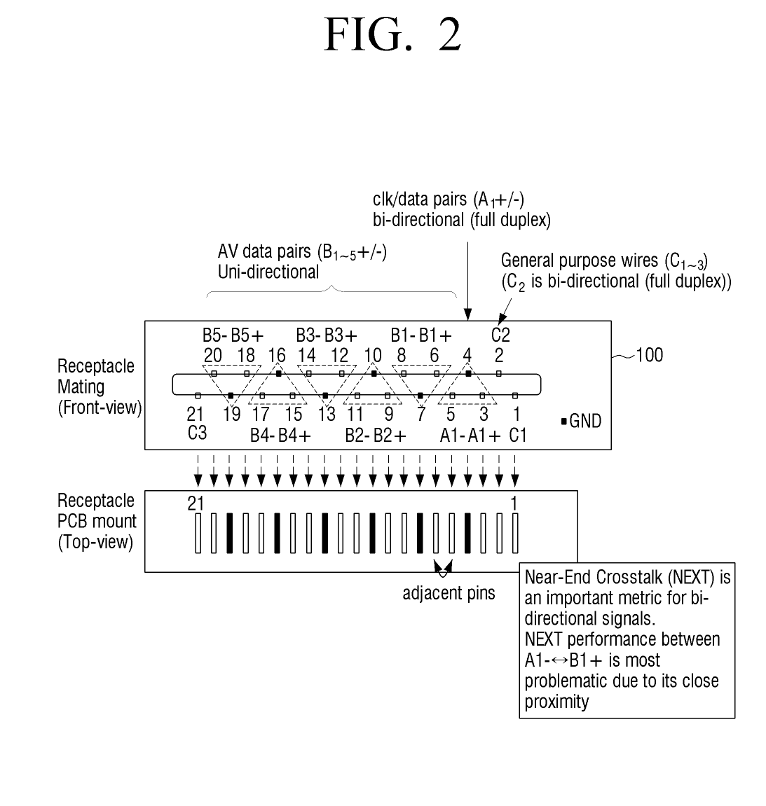

FIG. 2 is a diagram illustrating the structure of a 21 pin connector 100 according to an exemplary embodiment.

As illustrated in FIG. 2, according to an exemplary embodiment, the connector 100 including 21 pins may be defined. The connector 100 includes 6 data pairs for high-speed data transmission. The 6 data pairs includes 5 pins B1+/−, B2+/−, B3+/−, B4+/− and B5+/− having uni-directional signals, and one pin A1+/− having a bi-directional signal. In addition, the connector 100 has three general-purpose (single-ended) pins including C1 responsible for power, C2 responsible for control and C3 responsible for identification. C2 transmits a bi-directional signal. In addition, the connector 100 further includes 6 ground pins.

C3 is used for authentication of a device/cable and thus has relatively small traffic. C3 has very low data transmission rate, is mainly used in a device discovery operation, and is not used in a subsequent normal operation.

The 21 pin connector 100 may have characteristics of a high-speed uni-directional signal and characteristics of a high-speed bi-directional signal. In order to transmit AV data through a high-speed uni-directional signal or to transmit different data, different pins may be used. In order to transmit a clock signal through a high-speed bi-directional signal or to transmit other general environment configuration data, different pins may be used, or a single-ended pin may be used. On the other hand, the connector 100 may have low-speed general-purpose signal characteristics. The connector may transmit control data, power signals and authentication signals through low-speed signals.

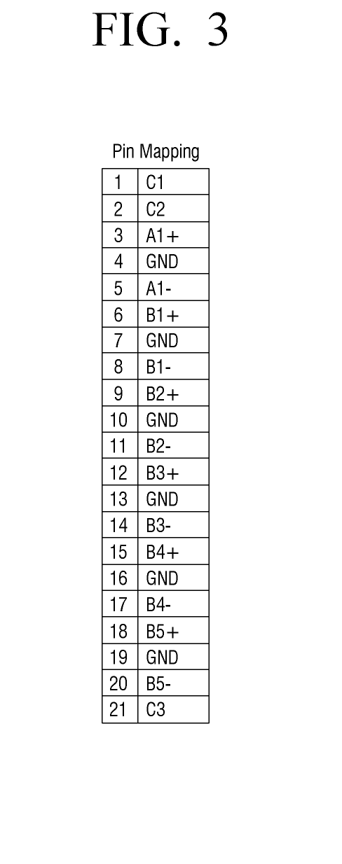

FIG. 3 is a diagram illustrating a pin arrangement order of the connector 100.

As illustrated in FIG. 3, pins may be sequentially arranged in such a way that pin #1 is C1, pin #2 is C2, pin #3 is A1+, pin #4 is GND, pin #5 is A1−, pin #6 is B1+, pin #7 is GND, pin #8 is B1−, pin #9 is B2+, pin #10 is GND, pin #11 is B2−, pin #12 is B3+, pin #13 is GND, pin #14 is B3−, pin #15 is B4+, pin #16 is GND, pin #17 is B4−, pin #18 is B5+, pin #19 is GND, pin #20 is B5−, and pin #21 is C3.

However, this pin arrangement causes near-end crosstalk (NEXT) between adjacent pins. NEXT is an important reference of measurement for bi-directional signals A1+/− and C2. For example, since A1+/− is a bi-directional signal, a connector needs to ensure that a NEXT between A1+/− and other pins is less than a predefined signal value. NEXT is measured between the following pins.
A1− [symbol] {B1+/−, B2+/−, B3+/−, B4+/−, B5+/−}
A1+ [symbol] {B1+/−, B2+/−, B3+/−, B4+/−, B5+/−}
C2 [symbol] {B1+/−, B2+/−, B3+/−, B4+/−, B5+/−}

According to the aforementioned exemplary embodiment, due to proximity between a pin A1− and a pin B1+, NEXT is caused which exceeds a limitation defined in the connector specification. This is because A1− and B1+ are physically adjacent to each other.

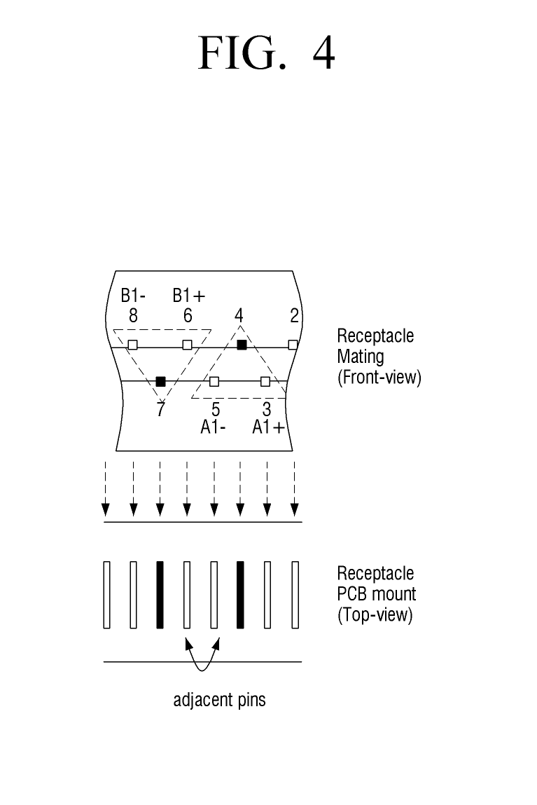

FIG. 4 is a diagram which illustrates a physical proximity between a pin A1− and a pin B1+.

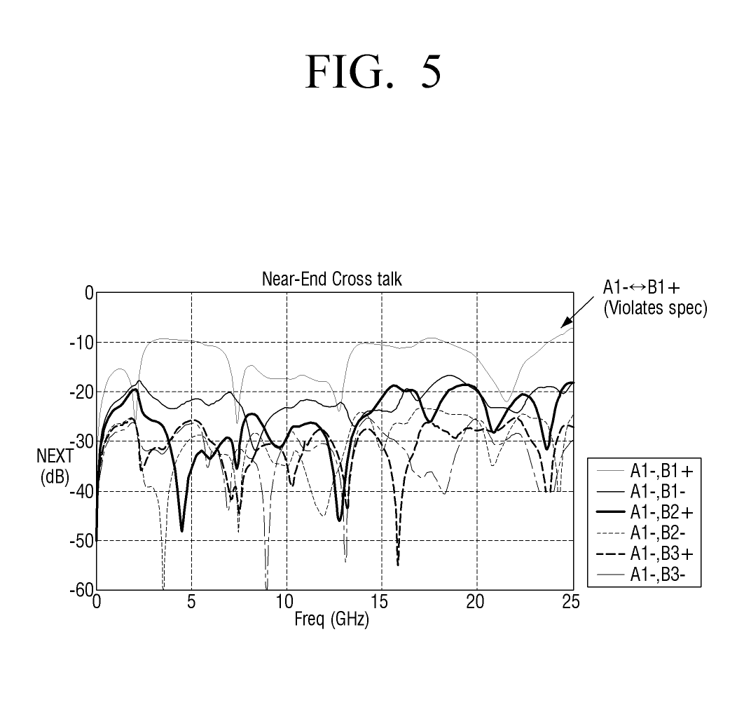

As illustrated in FIG. 4, the pin A1− and the pin B1+ are physically most adjacent to each other and have highest possibility of causing NEXT. FIG. 5 shows this result.

FIG. 5 is a diagram illustrating a NEXT value between adjacent pins.

As seen from FIG. 5, NEXT between the pin A1− and the pin B1+ that are physically most adjacent to each other remarkably exceeds a predefined value in the specification. NEXT between a pin A1− and a pin B1− has a large value.

Specifically, pin arrangement design for further reducing NEXT is possible. For ideal performance during high-speed data transmission, high-speed data pairs A1 and B1 to B5 are located in the middle of a connector. However, it is important to minimize crosstalk between high-speed data pairs.

In general, in consideration of the length of a cable and plug/accommodation portion, far-end crosstalk (FEXT) may be easily controlled. On the other hand, in consideration of NEXT, pins need to be arranged differently.

The aforementioned problem is overcome by varying pin arrangement.

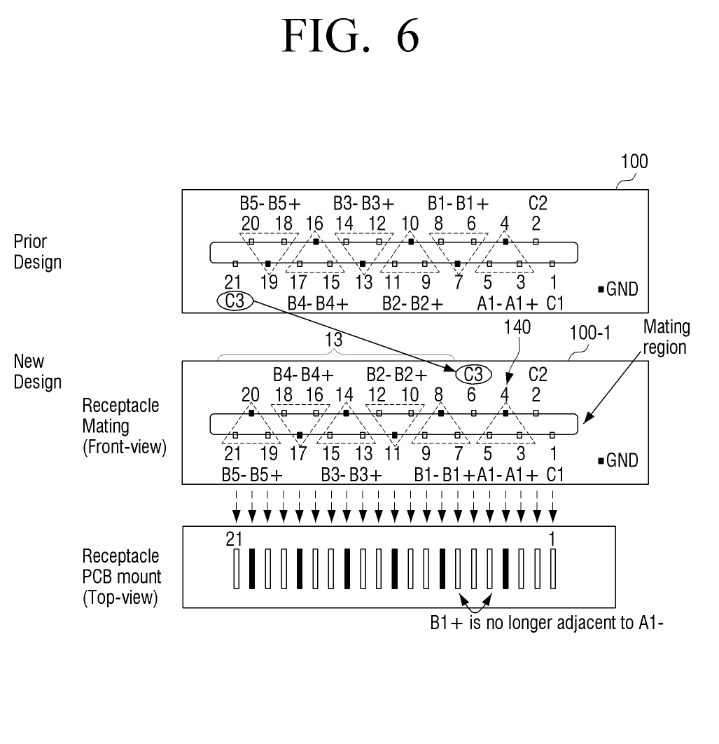

FIG. 6 is a diagram which illustrates pin arrangement of a connector 100-1, according to an exemplary embodiment.

Referring to FIG. 6, the connector 100-1 having a new design according to an exemplary embodiment includes a first pin set 130 having sequentially arranged pins for transmitting a uni-directional signal, a single ended pin adjacent to the first pin set 130, and a second pin set 140 adjacent to the single ended pin and having sequentially arranged pins for transmitting a bi-directional signal.

In this case, the first pin set 130 includes a plurality of pins for transmitting audio/video (AV) data through a high-speed uni-directional signal. The first pin set 130 may have sequentially arranged pins B1+, B1−, B2+, B2−, B3+, B3−, B4+, B4−, B5+, and B5−, for transmitting uni-directional signals.

The single ended pin may be a pin C3 for transmitting an identification signal.

In this case, an appearance of a connector is maintained and pins are re-arranged while occupying the same space. In response to an assumption that the pin C3 barely perform any operations, even in response to the pin C3 being disposed between the pin A1− and the pin B1+, as illustrated in FIG. 6, the pin C3 does not affect the pin A1− and the pin B1+.

The second pin set 140 may include a plurality of pins that transmits a clock signal through a high-speed bi-directional signal or transmits environment configuration data, and pins A1+ and A1− for transmitting a bi-directional signal may be sequentially arranged.

In addition, the connector 100-1 may further include a single ended end pin adjacent to the second pin set 140. In this case, all pins of a connector occupy the same space.

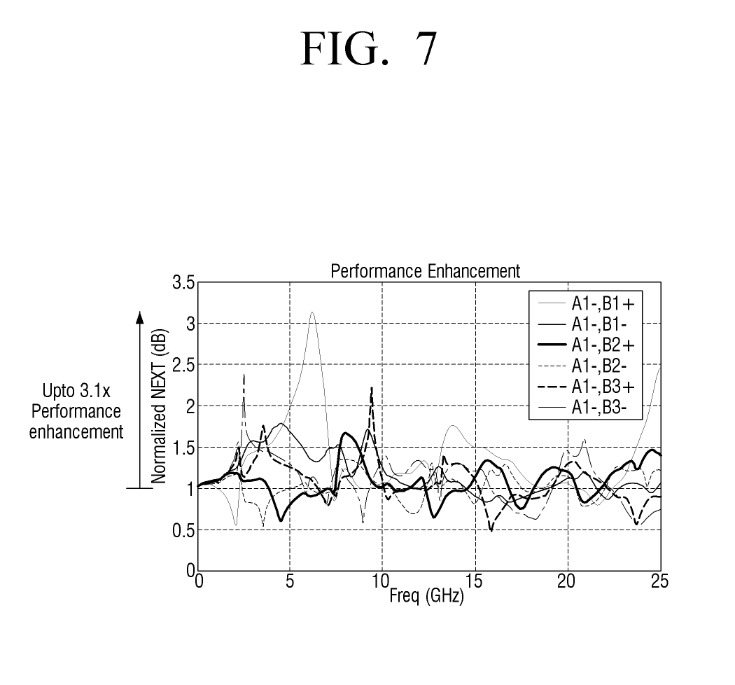

The aforementioned connector design remarkably reduces NEXT. FIG. 7 shows this result.

That is, FIG. 7 is a diagram which illustrates a NEXT value between adjacent pins of an improved connector.

As seen in FIG. 7, a NEXT value between most adjacent pins A1− and B1+ is remarkably reduced. It may be seen that the NEXT value between the A1− and B1+ is improved by a maximum of three times.

In order to reduce NEXT, the first pin set 130 and the second pin set 140 may be physically separated from each other, as one method. Hereinafter, another exemplary embodiment will be described.

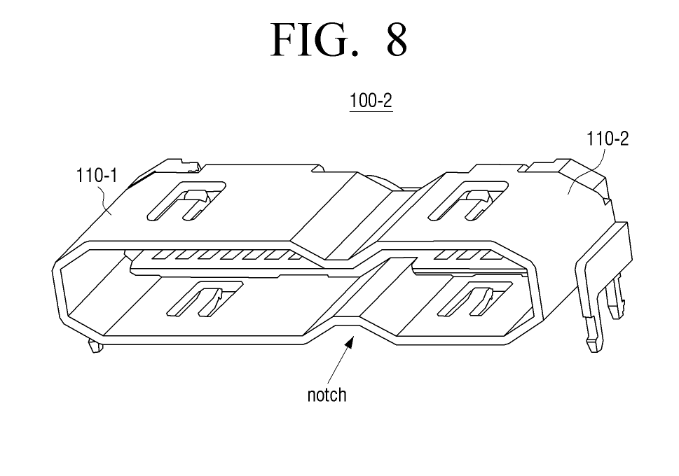

FIG. 8 is a diagram which illustrates the structure of an outer appearance of a connector 100-2 according to another exemplary embodiment.

Referring to FIG. 8, the connector 100-1 according to another exemplary embodiment includes a first housing 110-1 for accommodating a first pin set and a second housing 110-2 for accommodating a second pin set. The first housing 110-1 and the second housing 110-2 may be integrated with each other, may be connected to each other, as shown in FIG. 8, or may be spaced apart from each other or may be separately formed, unlike the connector in FIG. 8. In addition, in response to the first housing 110-1 and the second housing 110-2 being connected to each other, a coupling portion therebetween may be shaped like a bottle neck, as illustrated in FIG. 8. However, this is purely exemplary and a connector may have various external shapes.

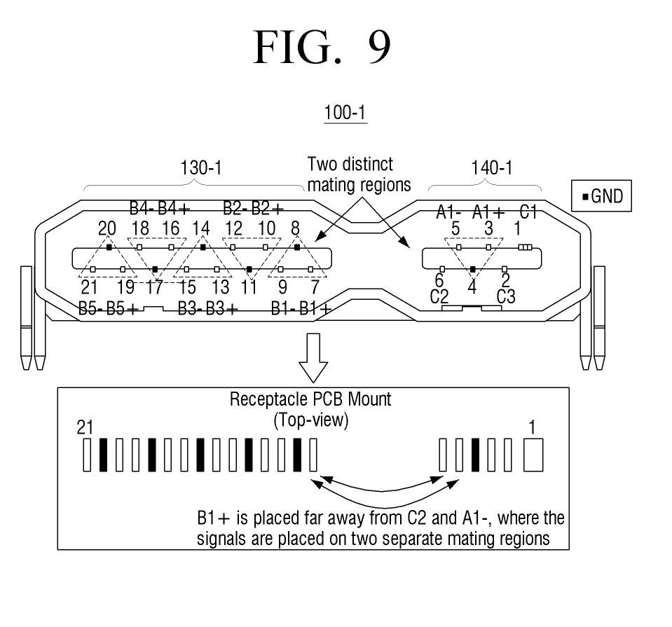

FIG. 9 is a diagram which illustrates an arrangement of pins of the connector 100-2 of FIG. 8.

Referring to FIG. 9, the connector 100-2 according to another exemplary embodiment includes a first pin set 130-1 having sequentially arranged pins for transmitting a uni-directional signal, and a second pin set 140-1 having sequentially arranged pins, disposed on substrates that are physically separated from each other.

The first pin set 130-1 may include a plurality of pins for transmitting AV data through a high-speed uni-directional signal and have sequentially arranged pins B1+, B1−, B2+, B2−, B3+, B3−, B4+, B4−, B5+ and B5−, for transmitting uni-directional signals.

The first pin set 130-1 and the second pin set 140-1 may be disposed on physically separated substrates or may be physically connected to each other but may be electrically insulated from each other by an insulator. In addition, the first pin set 130-1 and the second pin set 140-1 may be disposed on substrates that are physically separated from each other by an insulating plate.

The second pin set 140-1 may include a plurality of pins that transmits a clock signal through a high-speed bi-directional signal or transmits environment configuration data.

In addition, the second pin set 140-1 may include sequentially arranged pins A1+ and A1− for transmitting a bi-directional signal.

The connector 100-2 may further include a single ended pin set adjacent to the second pin set 140-1. The single ended pin set may include at least one of a pin C1 for transmitting a power signal, a pin C2 for transmitting a control signal, and a pin C3 for transmitting a device identification signal. As illustrated in FIG. 9, the connector 100-2 may be designed such that a pin A1− is adjacent to a pin C2 and a pin A1+ is adjacent to a pin C3.

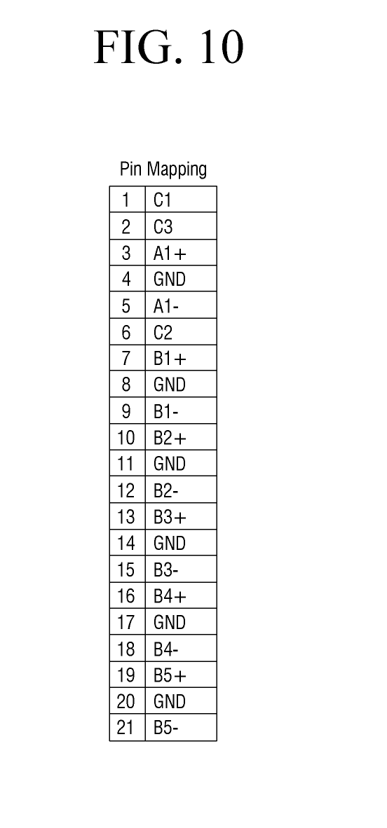

FIG. 10 is a diagram which illustrates an arrangement of pins of the connector 100-2.

As illustrated in FIG. 10, pins may be sequentially arranged in such a way that pin #1 is C1, pin #2 is C3, pin #3 is A1+, pin #4 is GND, pin #5 is A1−, pin #6 is C2, pin #7 is B1+, pin #8 is GND, pin #9 is B1−, pin #10 is B2+, pin #11 is GND, pin #12 is B2−, pin #13 is B3+, pin #14 is GND, pin #15 is B3−, pin #16 is B4+, pin #17 is GND, pin #18 is B4−, pin #19 is B5+, pin #20 is GND and pin #21 is B5−.

As described above, the connector 100-2 may be configured in such a way that pins A1+/− and C2 for transmitting a bi-directional signal and high-speed signal pins B1 to 5+/− are physically separated from each other, thereby reducing NEXT.

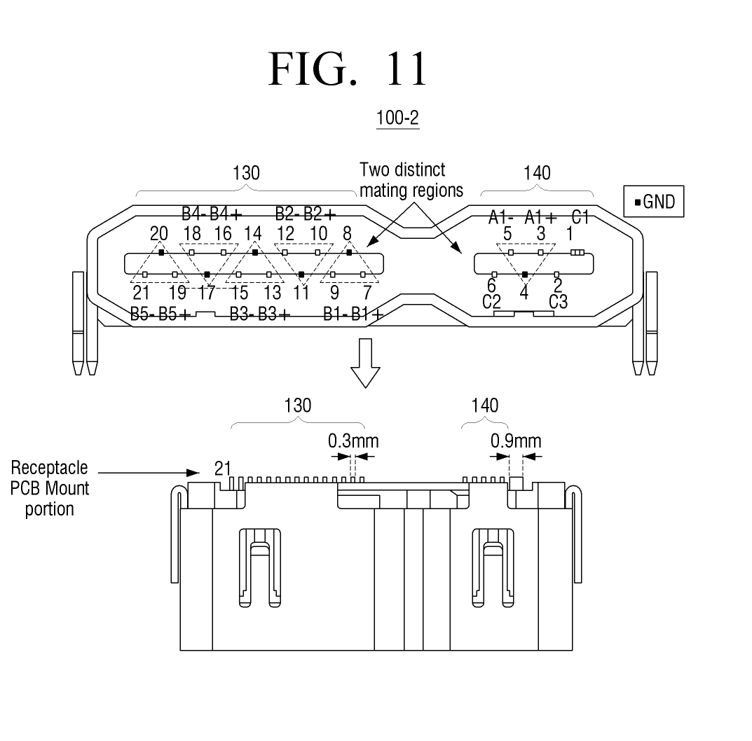

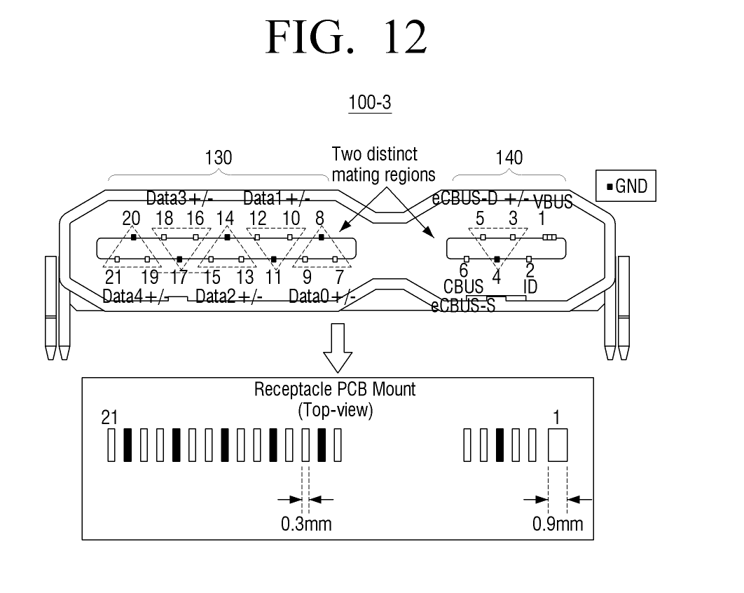

FIGS. 11 and 12 are diagrams which illustrate an arrangement of pins of the connector 100-2 according to another exemplary embodiment.

FIG. 11 illustrates arrangement of pins of the connector 100-2 and dimensions of the pins of the connector 100-2. The connector 100-2 may be designed in such a way that the first pin set 130-1 and the second pin set 140-1 are disposed on substrates that are physically separated from each other and each pin except for the pin C1 has a width of 0.3 mm. The pin C1 may be designed to have a wider width (e.g., 0.9 mm) than the other pins in order to transmit a power signal.

As described above, the pin C3 has very low data transmission rate, is mainly used in a device discovery operation, and is not used in a subsequent normal operation. The pin C3 has low activity and importance and thus is positioned adjacent to the pin C1.

Pins A1+/− and C2 transmit a bi-directional signal and simultaneously transmit a clock signal and a general data signal. The pins A1+/− and C2 have the same function, but the pin A1+/− supports very high bandwidth of 750 Mbps or more. The pins A1+/− and C2 are spaced apart from the pin C1 to reduce thermal impact of the pin C1. In addition, the pins A1+/− and C2 are physically separated from the pin B+/− to improve NEXT performance. With regard to the pins A1+/− and C2, the pin C2 is disposed at an edge portion and the pin A1+/− is disposed at a middle portion instead of the edge portion. Likewise, in response to the pin A1+/− being disposed at an inner part of second pin set 140-1, data transmission performance is improved.

The connector may be designed as illustrated in FIG. 12. That is, in the connector 100-3, a pin B1-5+/− may be replaced with a pin Data0-4+/−, a pin C1 may be replaced with a pin VBUS, a pin C3 may be replaced with a pin ID, a pin A1+/− may be replaced with a pin eCBUS-D+/−, and a pin C2 may be replaced with a pin eCBUS-S/CBUS.

The pin ID has very low data transmission rate, is mainly used in a device discovery operation, and is not used in a subsequent normal operation. The pin ID has low activity and importance and thus is positioned adjacent to the pin VBUS.

Pins eCBUS-D+/− and eCBUS-S/CBUS transmit a bi-directional signal and simultaneously transmit a clock signal and a general data signal. The pins eCBUS-D+/− and eCBUS-S/CBUS have the same function, but the pin eCBUS-D+/− supports very high bandwidth of 750 Mbps or more. The pins eCBUS-D+/− and eCBUS-S/CBUS are spaced apart from the pin VBUS to reduce thermal impact of the pin VBUS. In addition, the pins eCBUS-D+/− and eCBUS-S/CBUS are physically separated from the pin Data0-4+/− to improve NEXT performance. With regard to the pins eCBUS-D+/− and eCBUS-S/CBUS, the pin eCBUS-S/CBUS is disposed at an edge portion and the pin eCBUS-D+/− is disposed at a middle portion instead of the edge portion. Likewise, in response to the pin eCBUS-D+/− being disposed at an inner part, data transmission performance is improved.

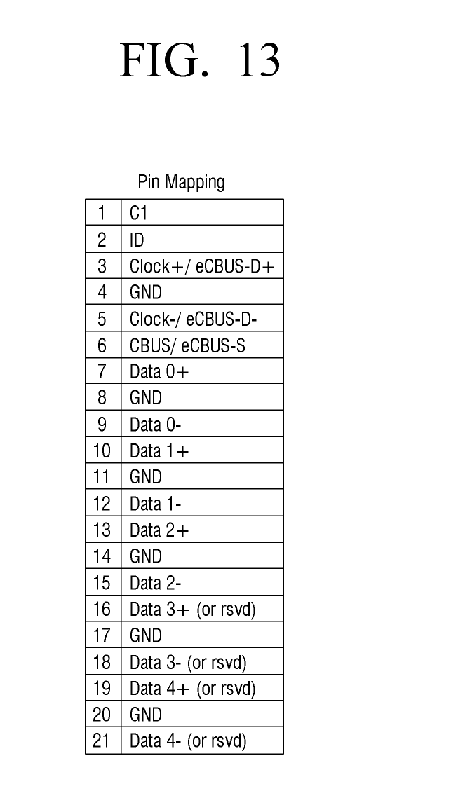

FIG. 13 is a diagram which illustrates a pin arrangement order of the connector 100-3.

As illustrated in FIG. 13, pins may be sequentially arranged in such a way that pin #1 is C1, pin #2 is ID, pin #3 is CLK+/eCBUS-D+, pin #4 is GND, pin #5 is CLK−/eCBUS-D−, pin #6 is CBUS/eCBUS-S, pin #7 is Data 0+, pin #8 is GND, pin #9 is Data 0−, pin #10 is Data 1+, pin #11 is GND, pin #12 is Data 1−, pin #13 is Data 2+, pin #14 is GND, pin #15 is Data 2−, pin #16 is Data 3+ (or rsvd), pin #17 is GND, pin #18 is Data 3+ (or rsvd), pin #19 is Data 4+ (or rsvd), pin #20 is GND and pin #21 is Data 4− (or rsvd).

The foregoing exemplary embodiments and advantages are merely exemplary and are not to be construed as limiting The present teachings can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A connector comprising:
a first pin set having sequentially arranged pins configured to transmit a uni-directional signal;
a single ended pin adjacent to the first pin set; and
a second pin set having sequentially arranged pins adjacent to the single ended pin and having sequentially arranged pins configured to transmit a bi-directional signal.

2. The connector as claimed in claim 1, wherein the first pin set comprises a plurality of pins configured to transmit audio/video (AV) data through a high-speed uni-directional signal.

3. The connector as claimed in claim 1, wherein the first pin set has sequentially arranged pins B1+, B1−, B2+, B2−, B3+, B3−, B4+, B4−, B5+, and B5− and transmits a uni-directional signal.

4. The connector as claimed in claim 1, wherein the single ended pin transmits a device identification signal.

5. The connector as claimed in claim 1, wherein the second pin set comprises a plurality of pins configured to transmit a clock signal through a high-speed bi-directional signal or to transmit environment configuration data.

6. The connector as claimed in claim 1, wherein the second pin set comprises sequentially arranged pins A1+ and A1− and transmits a bi-directional signal.

7. The connector as claimed in claim 1, further comprising a single ended pin adjacent to the second pin set.

8. A connector comprising:
a first pin set having sequentially arranged pins configured to transmit a uni-directional signal; and
a second pin set having sequentially arranged pins configured to transmit a bi-directional signal, wherein the first and second pin sets are disposed on physically separated substrates.

9. The connector as claimed in claim 8, wherein the first pin set comprises a plurality of pins configured to transmit audio/video (AV) data through a high-speed uni-directional signal.

10. The connector as claimed in claim 8, wherein the first pin set has sequentially arranged pins B1+, B1−, B2+, B2−, B3+, B3−, B4+, B4−, B5+, and B5− and transmits a uni-directional signal.

11. The connector as claimed in claim 8, wherein the second pin set comprises a plurality of pins configured to transmit a clock signal through a high-speed bi-directional signal or transmitting environment configuration data.

12. The connector as claimed in claim 8, wherein the second pin set comprises sequentially arranged pins A1+ and A1− and transmits a bi-directional signal.

13. The connector as claimed in claim 8, further comprising a single ended pin adjacent to the second pin set.

14. The connector as claimed in claim 13, wherein the single ended pin set comprises at least one of a pin C1 configured to transmit a power signal, a pin C2 configured to transmit a control signal, and a pin C3 configured to transmit a device identification signal.

15. The connector as claimed in claim 8, wherein the first pin set and the second pin set disposed on substrates are physically separated by an insulating plate.

16. The connector as claimed in claim 14, wherein the pin C2 is positioned inside the connector.

17. A connector comprising:
a pin set having sequentially arranged pins comprising:
a uni-directional pin C1 configured to transmit a power signal;
a bi-directional pin C2 configured to transmit a control signal;
a bi-directional pin A1+ configured to transmit a clock signal or to transmit environment configuration data;
a ground pin (GND);
a bi-directional pin A1− configured to transmit a clock signal or to transmit environment configuration data;
a uni-directional pin C3 configured to transmit a device identification signal;
a uni-directional pin B1+ configured to transmit audio/video (AV) data;
a ground pin (GND);
a uni-directional pin B1− configured to transmit AV data;
a uni-directional pin B2+ configured to transmit AV data;
a ground pin (GND);
a uni-directional pin B2− configured to transmit AV data;
a uni-directional pin B3+ configured to transmit AV data;
a ground pin (GND);
a uni-directional pin B3− configured to transmit AV data;
a uni-directional pin B4+ configured to transmit AV data;
a ground pin (GND);
a uni-directional pin B4− configured to transmit AV data;
a uni-directional pin B5+ configured to transmit AV data;
a ground pin (GND);
a uni-directional pin B5− configured to transmit AV data.

18. A connector comprising a first pin set and a second pin set,
wherein the first pin set has sequentially arranged pins comprising:
a uni-directional pin C1 configured to transmit a power signal;
a uni-directional pin C3 configured to transmit a device identification signal;
a bi-directional pin A1+ configured to transmit a clock signal or to transmit environment configuration data;
a ground pin (GND);
a bi-directional pin A1− configured to transmit a clock signal or to transmit environment configuration data; and
a bi-directional pin C2 configured to transmit a control signal,
wherein the second pin set has sequentially pins comprising:
a uni-directional pin B1+ configured transmit AV data;
a ground pin (GND);
a uni-directional pin B1− configured transmit AV data;
a uni-directional pin B2+ configured transmit AV data;
a ground pin (GND);
a uni-directional pin B2− configured transmit AV data;
a uni-directional pin B3+ configured transmit AV data;
a ground pin (GND);
a uni-directional pin B3− configured transmit AV data;
a uni-directional pin B4+ configured transmit AV data;
a ground pin (GND);
a uni-directional pin B4− configured transmit AV data;
a uni-directional pin B5+ configured transmit AV data;
a ground pin (GND); and
a uni-directional pin B5− configured transmit AV data, and
wherein the first pin set and the second pin set are disposed on physically separated substrates.

19. A connector comprising:
a first pin set having sequentially arranged pins configured to transmit a uni-directional signal; and a second pin set having sequentially arranged pins configured to transmit a bi-directional signal, wherein the first and second pin sets are separated so as to reduce near-end crosstalk (NEXT).

20. The connector of claim 19, further comprising a single ended pin adjacent to the first pin set, wherein the single ended pin is configured to transmit a device identification signal.
